(19) United States
(12) Patent Application Publication
(10) Pub. No.: US 2008/0137794 A1
(43) Pub. Date: Jun. 12, 2008

(54) Systems and methods for loading and transferring spent nuclear fuel

(75) Inventors: Gary Tjersland, Atlanta, GA (US); Tom Danner, Norcross, GA (US); George Carver, Norcross, GA (US); Charles W. Pennington, Alpharetta, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: NAC International, Inc.

(21) Appl. No.: 11/291,727

(22) Filed: Dec. 1, 2005

(51) Int. Cl. G21C 19/00

(52) U.S. Cl. 376/272

(57) ABSTRACT

Disclosed are systems and methods for loading and transferring spent nuclear fuel. In one embodiment, among others, the system comprises a transfer cask that contains spent nuclear fuel and shields radioactivity of the spent nuclear fuel, and an immersion tank that receives transfer casks within. The immersion tank has fluid that is circulated in the immersion tank, thereby cooling and providing shielding for the received transfer cask containing the spent nuclear fuel.

### TECHNICAL FIELD

The present invention is generally related to the handling of spent nuclear fuel.

### BACKGROUND

Dry nuclear spent fuel storage technology is deployed throughout the world to expand the capabilities of nuclear power plants to discharge and store spent nuclear fuel, thereby extending the operating lives of the power plants. Typically, two fundamental classes of technology are used in dry nuclear spent fuel storage: metal-based storage systems having metal casks, which are directly loaded and prepared for storage in the spent fuel pool at the power plant, and canister-based storage systems having transfer casks, which typically involve a limited time period to close (seal) and to transfer into a storage overpack. FIG. 1 is a schematic diagram of a representative process for loading, transferring, and storing spent nuclear fuel using canister-based storage systems. In step 1, the canister 9 is first loaded into a transfer cask 10. In step 2, the canister 9, while within the transfer cask 10, is placed into a spent fuel pool 11. In step 3, while the canister 9 and transfer cask 10 are in the spent fuel pool 11, spent nuclear fuel 12 is loaded into the canister 9 using a lifting device 14. In step 4, the lifting device 14 places a shield plug on top of the canister 9. In step 5, the transfer cask 10, along with the canister 9 and spent nuclear fuel 12, is removed from the spent fuel pool 11 to a dry preparation area for draining and drying of the canister 9, as well as welding of confinement closures onto the canister 9. In steps 6, 7, and 8, the canister 9 is transferred from the transfer cask 10 into an on-site storage cask 16 and then moved to vertical storage area 20.

One design feature, among others, of canister-based storage systems is directed at limiting the temperatures of the spent nuclear fuel while loading the spent nuclear fuel into the canisters at the power plants. This becomes a difficult technical design task, particularly if the spent nuclear fuel has in-reactor burnup and/or post-reactor cooling period characteristics that cause the spent nuclear fuel to have high heat generation rates. Such high heat generation rates cause spent nuclear fuel and canister material temperatures to increase rapidly, reducing the amount of time available to weld closures on the canisters before temperature limits are exceeded, particularly during step 5 of FIG. 1. Further, spent nuclear fuel with such high heat generation rates is also a source of high radiation, which can elevate the ionizing radiation exposure of workers involved in closing the canisters and transferring them into on-site storage casks. Workers are limited in the amount of such radiation exposure they can receive, and spent nuclear fuel with high heat generation rates makes the task of keeping worker exposures to ionizing radiation as low as reasonably achievable (ALARA) more difficult.

### SUMMARY

Disclosed are systems and methods for loading and transferring spent nuclear fuel. In one embodiment, among others, the system comprises a transfer cask that contains spent nuclear fuel and shields radioactivity of the spent nuclear fuel, and an immersion tank that receives transfer casks within. The immersion tank has fluid that is circulated in the immersion tank, thereby cooling and providing shielding for the received transfer cask containing the spent nuclear fuel. It should be noted that the immersion tank is capable of not only receiving transfer casks based on canister-based storage systems, but also metal casks based on metal-based storage systems.

In another embodiment, among others, a method for loading and transferring spent nuclear fuel comprises: loading spent nuclear fuel into a canister; loading the canister along with spent nuclear fuel into a transfer cask; loading the transfer cask along with the spent nuclear fuel into an immersion tank; and circulating fluid within the immersion tank and an annulus located between the cask and canister using a closed loop, thereby cooling and providing shielding for the transfer cask and canister containing spent nuclear fuel.

Other systems, methods, features, and advantages of the present invention will be or become apparent to one with skill in the art upon examination of the following drawings and detailed description. It is intended that all such additional systems, methods, features, and advantages included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, the same reference numerals designate corresponding parts throughout the several views.

FIG. 1 is a schematic diagram of a representative conventional process for loading, transferring, and storing spent nuclear fuel using canister-based storage systems.

FIG. 2 is a cross-sectional, side view of an embodiment of a system for loading and transferring spent nuclear fuel, showing details of a canister within a transfer cask.

FIG. 3 is a top view of the embodiment of the canister and the transfer cask, as shown in FIG. 2, within an immersion tank.

FIG. 4 is a side view of the embodiment of FIG. 3.

FIG. 5 is a cross-sectional, side view of another embodiment of a system for loading and transferring spent nuclear fuel.

FIG. 6 is a partially cutaway, side view of another embodiment of a system for loading and transferring spent nuclear fuel.

FIG. 7 is a flow diagram that illustrates an embodiment of a method for loading and transferring spent nuclear fuel.

### DETAILED DESCRIPTION

The systems and methods disclosed herein potentially limit both canister temperatures and radiation dose rates so that the loading, closure, and transfer of canister-based storage systems have a reduced likelihood of reaching temperature and personnel radiation exposure limits. In this regard, exemplary embodiments of such systems are first discussed with reference to the figures. Such systems are provided for purposes of illustration only and various modifications are feasible. After the exemplary systems have been described, exemplary embodiments of methods of loading and transferring spent nuclear fuel are discussed.

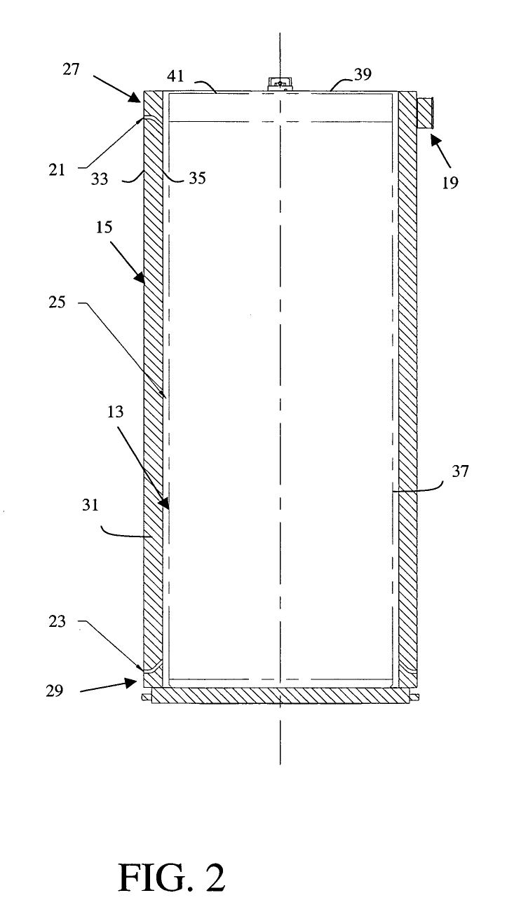

Referring once again to the figures, FIG. 2 is a cross-sectional, side view of an embodiment of a system for loading and transferring spent nuclear fuel, showing details of a canister within a transfer cask. The canister 13 and transfer cask 15 in this embodiment are both cylindrical; however, in other embodiments, different configurations such as square, rectangular, cubical, hexagonal, heptagonal, and octagonal, among others, can be used.

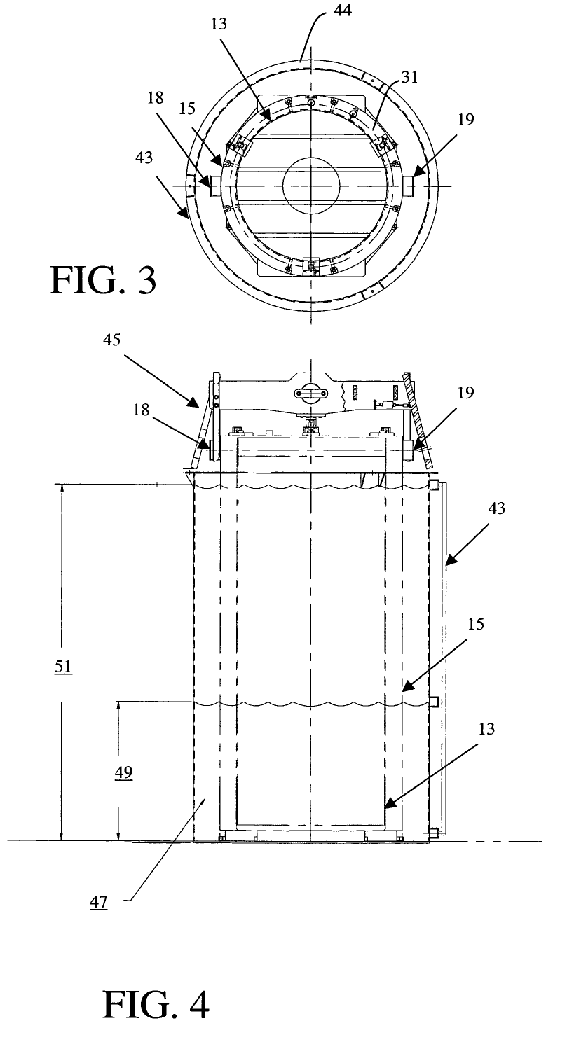

The transfer cask 15 includes a lifting trunnion 19 that is attached to the sidewall 31 of the transfer cask 15 adjacent to the top portion 27 of the transfer cask 15 to facilitate loading the transfer cask 15 into and out of both an immersion tank and spent fuel pool, each of which is not shown in FIG. 2 and will be discussed later. In particular, the immersion tank 43 is illustrated and discussed in relation to FIGS. 3-5. The transfer cask 15 provides for both the handling of the contained canister 13 (holding the spent nuclear fuel) and for the shielding of the radioactive spent nuclear fuel. The transfer cask 15 is designed to provide adequate clearances around the canister 13 to permit convective flow of fluid 25, which can be either liquid or an appropriate gas. In other words, the transfer cask 15 includes a sidewall 31 and a top wall 39 that are spaced apart from the sidewall 37 and top wall 41 of the canister 13, respectively, to permit convective flow of fluid 25 within the transfer cask 15 around the canister 13.

The transfer cask 15 further includes low flow resistance inlet 23 and outlet 21 to facilitate the convective flow of fluid 25 and the removal of heat from the canister 13. Each of the low flow resistance inlet 23 and outlet 21 is a slot through the sidewall 31 of the transfer cask 15 to permit intake or outtake of fluid, respectively, for the transfer cask 15. The low flow resistance inlet 23 and outlet 21 are located adjacent to the bottom portion 29 and top portion 27 of the sidewall 31 of the transfer cask 15, respectively. The slot of the inlet 23 is slanted downwards from the inner surface 35 to the outer surface 33 of the sidewall 31 of the transfer cask 15. The slot of the low flow resistance outlet 21 is slanted upwards from the inner surface 35 to the outer surface 33 of the sidewall 31 of the transfer cask 15. In other embodiments, different configurations of low flow resistance inlets and outlets can be used. For spent nuclear fuel within the canister 13 having large heat loads, the flow rates of the convected cooling medium within the transfer cask 15 around the canister 13 may be high, and the transfer cask 15 is designed to remove adequate heat from the canister 13 through the use of appropriate clearances for the convective flow mentioned above and low flow resistance inlet 23 and outlet 21 designs. The canister 13 with the contained spent nuclear fuel having very high heat generation rates does not rely on simple heat conduction across tight air-gaps in the transfer cask 15, but rather has ample clearances and coolant flow through inlet 23 and outlet 21 to permit convective cooling of the canister 13.

After the spent nuclear fuel is loaded into the canister 13 while in the spent fuel pool, the canister 13 within the transfer cask 15 is loaded into an immersion tank 43. Such immersion tank 43 is typically located in a dry preparation area (not shown) for draining and drying of the canister 13 that is preferably in close proximity to the spent fuel pool. FIG. 3 is a top view of an embodiment of the canister and the transfer cask, as shown in FIG. 2, within the immersion tank. The immersion tank 43 is cylindrical, but in other embodiments, different configurations such as square, rectangular, cubical, hexagonal, heptagonal, and octagonal, among others, can be used. The immersion tank 43 includes a sidewall 44 that is spaced apart from the sidewall 31 of the transfer cask 15 to permit convective flow of fluid within the immersion tank 43. It should be noted that the transfer cask 15 shown in FIG. 3 includes two lifting trunnions 18, 19.

FIG. 4 illustrates a side view of an embodiment of the canister and the transfer cask, as shown in FIG. 2, within the immersion tank. The lifting trunnions 18, 19 engage a lifting fixture 45 attached to a lifting device, such as a crane (not shown). Such a lifting device lifts the transfer cask 15 from the spent fuel pool into the immersion tank 43. The immersion tank 43 can be mobile and movable so that the immersion tank 43 may be used with certain canisters that require cooling and not used with others that are already sufficiently cooled. This provides operators with the flexibility to load a variety of canisters without the need for the tank and to use the tank for other canisters having high heat loads. It should be noted that the immersion tank is capable of not only receiving transfer casks based on canister-based storage system, but also metal casks based on metal-based storage systems.

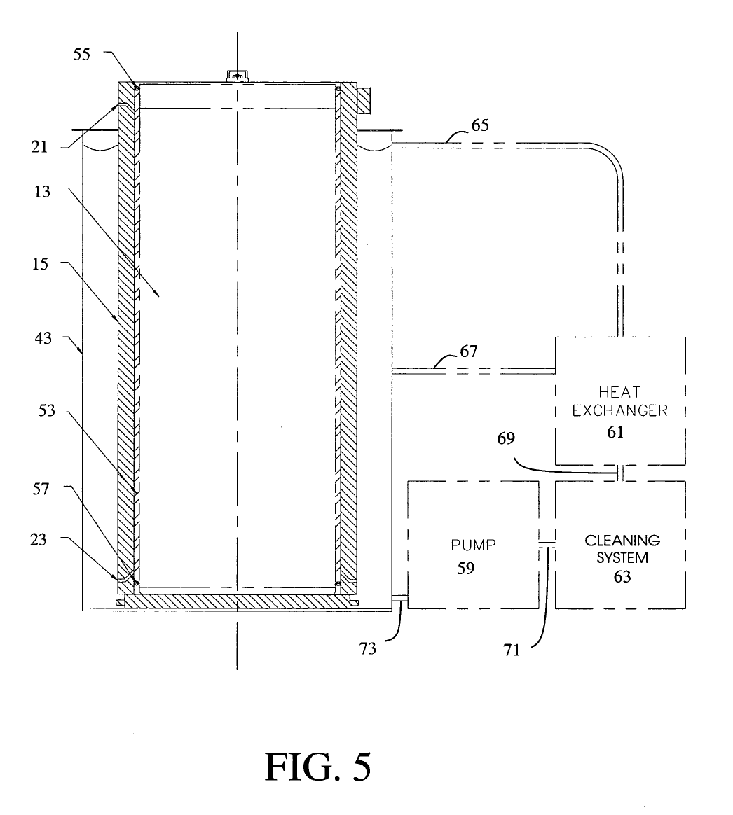

A small quantity of clean fluid 47, approximately 3,000 gallons of liquid in this embodiment, can be pumped into the immersion tank 43 to the level 49 before the transfer cask 15 containing the loaded canister 13 is loaded into the immersion tank 43. After loading the transfer cask 15, spent nuclear fuel, and the canister 13, the clean fluid 47 rises to level 51 in the immersion tank 43. The fluid 47 in the immersion tank 43 can be circulated in a closed loop that includes a pump 59, a cooled heat exchanger 61, and a cleaning system 63, which are illustrated and described in relation to FIG. 5. The immersion tank 43 design assures an effective cooling of the canister 13 to provide workers the necessary time to perform the closure and drying operations for the canister 13 without the threat of exceeding material or fuel temperatures.

FIG. 5 is a cross-sectional, side view of another embodiment of a system for loading and transferring spent nuclear fuel. This embodiment incorporates a closed loop. Specifically, fluid 47 (e.g., water) is pumped out of the immersion tank 43 through fluid line 73 into pump 59. The fluid 47 is transferred via fluid line 71 to the cleaning system 63 to clean the fluid, e.g., remove particulate, chemical, and radioactivity, among others. The fluid 47 is transferred via fluid line 69 to heat exchanger 61 for cooling the fluid 47. The cooled fluid 47 is pumped back into the immersion tank 43 via fluid lines 65, 67, thereby cooling the canister 13. The closed cooling loop may incorporate redundancy features to assure operability under a variety of normal, off-normal, or accident conditions.

The transfer cask 15 further includes upper and lower seals 55, 57 that seal the canister 13 within the transfer cask 15 at the top portion 27 and bottom portion 29 of the transfer cask 15 and above and below the low resistance outlet 21 and inlet 23, respectively. With these seals, the canister 13 can be surrounded by a separate fluid jacket 53 by connecting the low resistance inlet 23 and outlet 21 to a separate circulation loop (not shown) that supplies the separate fluid jacket 53 while the canister 13 is in the immersion tank 43. The separate fluid jacket 53 is not open to the fluid in the immersion tank 43; and hence, minimizes contamination of the immersion tank cooling fluid. The transfer cask internal and canister external contamination levels may be reduced by using the separate fluid jacket 53 around the canister 13 in the immersion tank 43 and, if desired, circulating cooling fluid purification, particularly to the canister 13 and the transfer cask 15, for cleanup, thereby reducing the need for workers to decontaminate the system and the associated radiation exposure to workers from performing decontamination. It should be noted that for the situation where a separate fluid jacket 53 is not used, the transfer cask 15 may or may not have the upper and lower seals 55, 57.

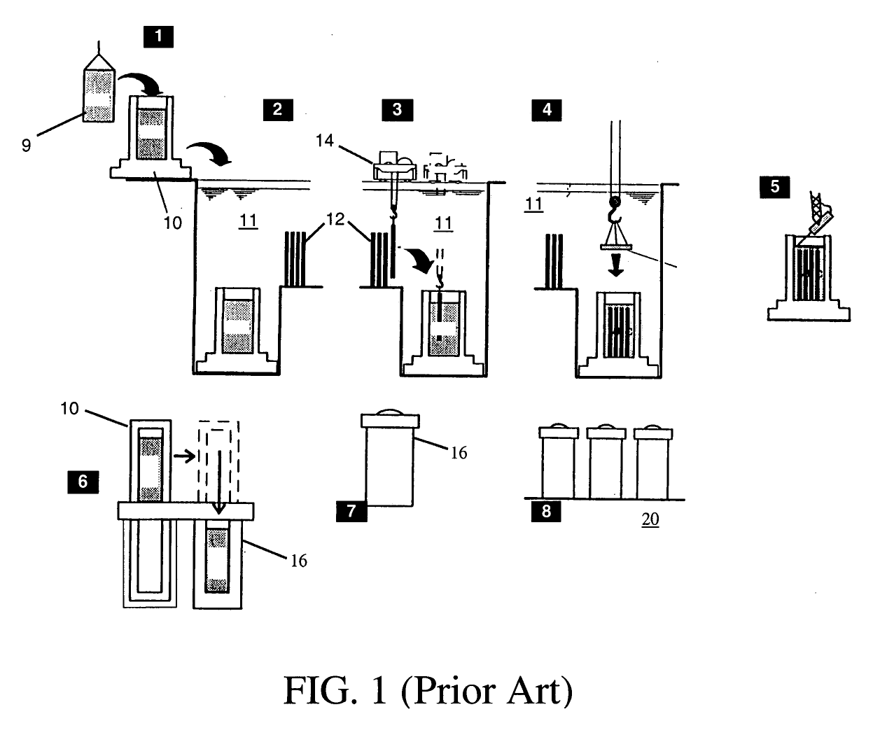

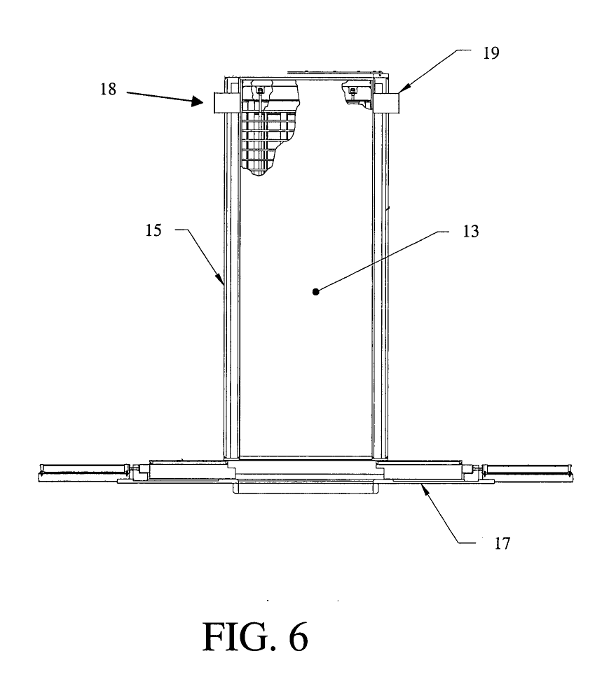

FIG. 6 is a partially cutaway, side view of another embodiment of a system for loading and transferring spent nuclear fuel. After the workers complete the closure and drying operation of the canister 13, the transfer cask 15 containing the loaded canister 13 is lifted out of the immersion tank 43 and placed on the transfer adapter 17 for use in transferring the canister 13 into the on-site storage cask, such as shown in step 6 of FIG. 1.

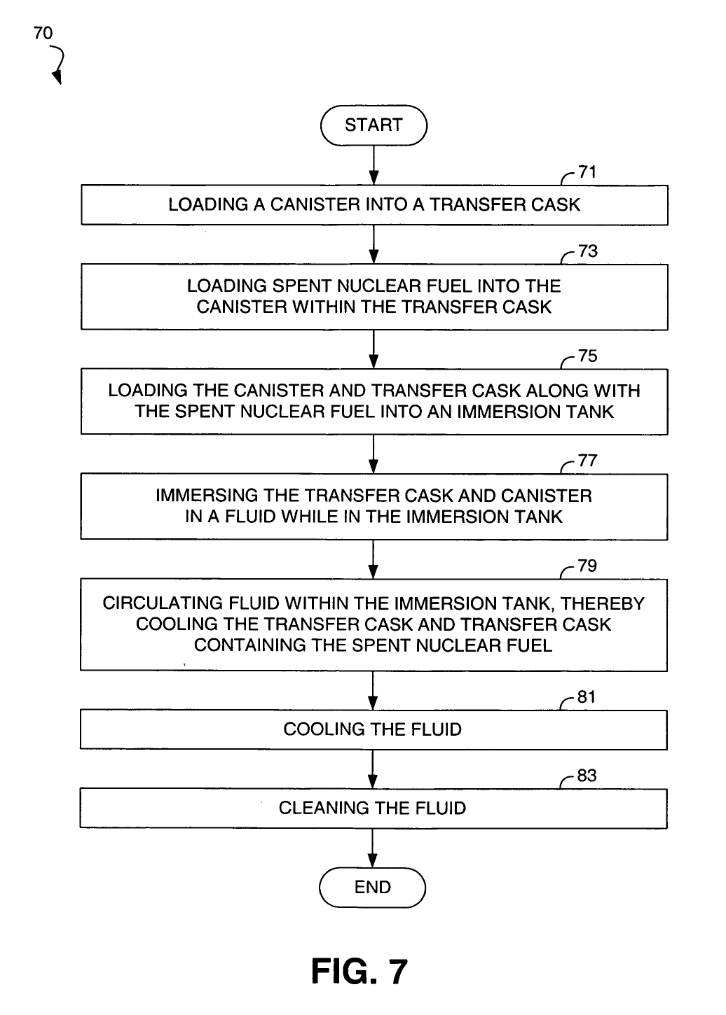

FIG. 7 is a flow diagram that illustrates an embodiment of a method for loading and transferring spent nuclear fuel. Beginning with step 71, the method includes the step of loading a canister into a transfer cask. In step 73, the spent nuclear fuel is loaded into the canister, preferably while the spent nuclear fuel, canister, and transfer cask are in the spent fuel pool. In step 75, the transfer cask along with the canister and spent nuclear fuel are loaded into an immersion tank. The immersion tank is preferably located in a dry preparation area outside of the spent fuel pool. In step 77, the transfer cask and canister are immersed in fluid while in the immersion tank. In step 77, the fluid is circulated within the immersion tank, thereby cooling and providing shielding for the transfer cask and canister. In step 81, the fluid is cooled and recirculated through the immersion tank 43. In step 83, the fluid is cleaned.

It should be emphasized that the above-described embodiments are simply possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A system for loading and transferring spent nuclear fuel, comprising:
a canister having a first sidewall that has a first height, the canister being operative to contain spent nuclear fuel;
a transfer cask having a second sidewall that has a second height, the transfer cask being operative to contain the canister and to shield radioactivity of the spent nuclear fuel, the transfer cask that contains the canister being operative to hp placed in a spent fuel pool, the spent fuel pool having a depth that is at least twice the height of the canister and transfer cask; and
an immersion tank having a third sidewall that has a third height, the third height of the immersion tank having substantially the first height of the canister, the immersion tank being placed at a dry preparation area for draining and drying the transfer cask and canister, the immersion tank being operative to receive the transfer cask and canister from the spent fuel pool and circulate fluid about the transfer cask and canister, thereby cooling and providing shielding for the received transfer cask containing the spent nuclear fuel during the process of draining and drying the transfer cask and canister, the third sidewall of the immersion tank being spaced apart from the second sidewall of the transfer cask to permit convective flow of fluid within the immersion tank.

2. The system of claim 1, further comprising a canister that is loaded with spent nuclear fuel and is located in the transfer cask.

3. The system of claim 2, wherein the transfer cask includes a sidewall and a top wall, the sidewall and the top wall being spaced apart from the sidewall and top wall of the canister, respectively, to permit convective flow of fluid within the transfer cask.

4. The system of claim 3, wherein the transfer cask includes a low flow resistance inlet and outlet to facilitate removal of heat from the canister, the inlet being located adjacent to the bottom portion of the sidewall of the transfer cask, the outlet being located adjacent to the top portion of the sidewall of the transfer cask.

5. The system of claim 4, wherein the low flow resistance inlet and outlet include slots through the sidewall of the transfer cask to permit intake or outtake of fluid for the transfer cask

6. The system of claim 4, wherein the slot of the inlet being slanted upwards from the inner surface to the outer surface of the sidewall of the transfer cask, the slot of the outlet being slanted downwards from the inner surface to the outer surface of the sidewall of the transfer cask

7. The system of claim 1, further comprising a pump that pumps the fluid into the immersion tank where the fluid circulates within the transfer cask.

8. The system of claim 7, further comprising a heat exchanger that cools the fluid before the fluid is pumped into the immersion tank.

9. The system of claim 7, further comprising a cleaning system that cleans the fluid before the fluid is pumped into the immersion tank.

10. The system of claim 7, wherein the fluid in the immersion tank circulates in a closed loop.

11. The system of claim 1, further comprising a transfer adapter that is used to transfer the canister along with the spent nuclear fuel into a storage cask.

12. The system of claim 1, wherein the transfer cask comprises lifting trunnions that are attached to the sidewall of the transfer cask adjacent to the top portion of the transfer cask to facilitate transferring the transfer cask into the immersion tank.

13. The system of claim 1, further comprising a fluid jacket covering the canister while the canister is in the immersion tank.

14. The system of claim 1, further comprising:
means for circulating the fluid within the immersion tank;
means for cooling the fluid before the fluid is pumped into the immersion tank; and
means for cleaning the fluid before the fluid is pumped into the immersion tank.

15-19. (canceled)

20. A system for loading and transferring spent nuclear fuel, comprising:
a transfer cask having a first sidewall that has a first height, the transfer cask being operative to contain spent nuclear fuel and to shield radioactivity of the spent nuclear fuel, the transfer cask that contains the canister being operative to be placed in a spent fuel pool, the spent fuel pool having a depth that is at least twice the height of the canister and transfer cask;
an immersion tank having a second sidewall that has a second height, the second height of the immersion tank having substantially the first height of the transfer cask, the immersion tank being placed at a dry preparation area for draining and drying the transfer cask and canister, the immersion tank being operative to receive the transfer cask and canister from the spent fuel pool and provide shielding for the received transfer cask containing the spent nuclear fuel during the process of draining and drying the transfer cask and canister, the second sidewall of the immersion tank being spaced apart from the second sidewall of the transfer cask to permit convective flow of fluid within the immersion tank;
a pump operative to pump fluid into the immersion tank and circulate the fluid within the transfer cask and in the immersion tank in a closed loop;
a heat exchanger operative to receive and cool the fluid before the fluid is pumped into the immersion tank; and
a cleaning system operative to receive and cleans the fluid before the fluid is pumped into the immersion tank.

21. An immersion tank that is placed at a dry preparation area for draining and drying the transfer cask and canister, comprising:
a bottom wall; and
a first sidewall that is attached to the bottom wall, the first sidewall having a first height, the first height of the immersion tank having substantially a second height of a second sidewall of a transfer cask, the transfer cask being operative to be placed in a spent fuel pool, the spent fuel pool having a depth that is at least twice the height of the canister and transfer cask, the first sidewall of the immersion tank being spaced apart from the second sidewall of the transfer cask to receive the transfer cask from the spent fuel pool, provide shielding for the received transfer cask containing the spent nuclear fuel, and permit convective flow of fluid within the immersion tank during the process of draining and drying the transfer cask and canister.

22. The immersion tank as defined in claim 21, further comprising a pump that is coupled to the first sidewall of the immersion tank, the pump being operative to pump fluid into the immersion tank and circulate the fluid within the transfer cask and in the immersion tank in a closed loop.

23. The immersion tank as defined in claim 22, further comprising a heat exchanger that is coupled to the first sidewall of the immersion tank, the heat exchanger being operative to receive and cool the fluid before the fluid is pumped into the immersion tank.

24. The immersion tank as defined in claim 23, further comprising a cleaning system operative to receive from the heat exchanger and clean the fluid before the fluid is pumped into the immersion tank.
